(19) United States
(12) Patent Application Publication
(10) Pub. No.: US 2026/0010323 A1
(43) Pub. Date: Jan. 8, 2026

(54) COMMUNICATION SYSTEM, PRINTER, AND NON-TRANSITORY COMPUTER-READABLE STORAGE MEDIUM STORING COMPUTER-READABLE INSTRUCTIONS FOR PRINTER

(71) Applicant: BROTHER KOGYO KABUSHIKI KAISHA, Nagoya (JP)

(72) Inventor: Yutaro SATO, Aisai (JP)

(21) Appl. No.: 19/254,828

(22) Filed: Jun. 30, 2025

(30) Foreign Application Priority Data
Jul. 2, 2024 (JP) 2024-106932

(51) Int. Cl. G06F 3/12

(52) U.S. Cl. CPC G06F 3/1259; G06F 3/1203; G06F 3/1231

(57) ABSTRACT

A first printer may repeatedly send first status information indicating a status of the first printer to the server. A second printer may repeatedly send second status information indicating a status of the second printer to the server. The first printer may cause a display to display a designation screen for designating a printer that is unable to send status information to the server, and send second printer identification information identifying the second printer to the server in a case where the second printer is designated in the designation screen after a state of the second printer has changed from a state of being able to send the second status information to the server to a state of being unable to send the second status information to the server. The server may output the second printer identification information externally.

### REFERENCE TO RELATED APPLICATIONS

This application claims priority from Japanese Patent Application No. 2024-106932 filed on Jul. 2, 2024. The entire content of the priority application is incorporated herein by reference.

### BACKGROUND ART

In a known image forming device, when an error occurs therein, the image forming device notifies a person near that image forming device or a person near an external device about the error.

### SUMMARY

In the known art, nothing is disclosed about a situation where an error occurs in which an image forming device is not able to communicate. The present teachings provide an art configured to allow output of information related to a printer when the printer is unable to send its status information.

A communication system including a first printer, a second printer, and a server is disclosed herein. The first printer may include a first printer controller configured to repeatedly send first status information indicating a status of the first printer to the server. The second printer may include a second printer controller configured to repeatedly send second status information indicating a status of the second printer to the server. The first printer may further include a display. The first printer controller may be further configured to cause the display to display a designation screen for designating a printer that is unable to send status information to the server. The first printer controller may be further configured to send second printer identification information identifying the second printer to the server in a case where the second printer is designated in the designation screen after a state of the second printer has changed from a state of being able to send the second status information to the server to a state of being unable to send the second status information to the server. The server may include a server controller configured to output the second printer identification information externally in a case where the second printer identification information is received from the first printer.

According to the above configuration, after the second printer has changed its state to the state of being unable to send the second status information to the server, the first printer can receive designation of the second printer by displaying the designation screen. In this case, the first printer sends the second printer identification information identifying the second printer to the server. As a result of this, the server can output the second printer identification information externally. As such, a repairman of a printer can acknowledge the second printer identification information, and can conduct repair work for resolving malfunction in the second printer.

The above-described first printer, a non-transitory computer-readable storage medium storing computer-readable instructions for the first printer, and a method executed by the first printer are also novel and useful. Further, the above-described server, a non-transitory computer-readable storage medium storing computer-readable instructions for the server, and a method executed by the server are also novel and useful.

### BRIEF DESCRIPTION OF DRAWINGS

FIG. 1 illustrates a configuration of a communication system.

FIG. 2 illustrates a sequence diagram of a management process for status information.

FIG. 3 illustrates a sequence diagram.

FIG. 4 illustrates a sequence diagram.

FIG. 5 illustrates a sequence diagram.

FIG. 6 illustrates a sequence diagram.

### DESCRIPTION

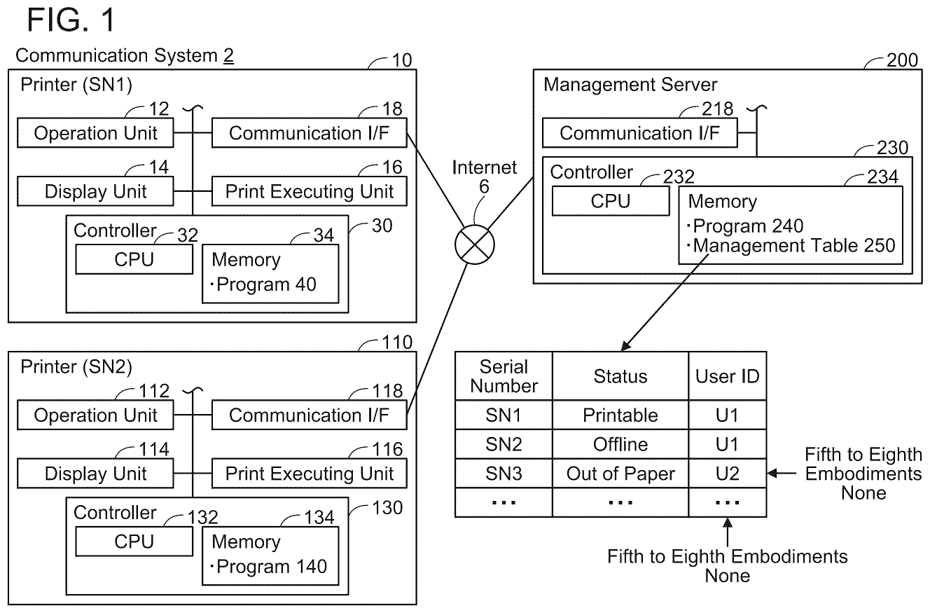

### (Outline of Communication System 2: FIG. 1)

As illustrated in FIG. 1, a communication system 2 comprises a plurality of printers 10, 110 and a management server 200. In the present embodiment, the printers 10, 110 belong to a same Local Area Network (LAN), and are usually configured to communicate with the management server 200 via the LAN and the Internet 6. Alternatively, however, the printers 10, 110 may belong to different LANs.

### (Configurations of Printers 10, 110)

The printer 10 has a serial number SN1. The printer 10 is a peripheral device configured to execute a print function, and is a peripheral device for an unillustrated PC, or smartphone, for example. In a modification, the printer 10 may be a multi-function peripheral configured to execute a scan function, a facsimile function, etc., in addition to the print function. The printer 10 comprises an operation unit 12, a display unit 14, a print executing unit 16, a communication interface 18, and a controller 30. The respective units 12 to 30 are connected to a bus line.

The operation unit 12 is a user interface configured to allow a user to input various information to the printer 10, and comprises a touch screen and/or button(s), for example. The display unit 14 is a display configured to display various information. The print executing unit 16 comprises for example an inkjet print mechanism, or a laser print mechanism. The communication interface 18 is an interface for belonging to a LAN by wired communication or wirelessly.

The controller 30 comprises a CPU 32 and a memory 34. The memory 34 is composed of a ROM, RAM, for example, and stores a program 40. The CPU 32 realizes various processes in accordance with the program 40 in the memory 34.

The printer 110 has a serial number SN2 different from the serial number of the printer 10. The printer 110 has a same configuration as the printer 10 except the different serial number. In other words, the printer 110 comprises an operation unit 112, a display unit 114, a print executing unit 116, a communication interface 118, and a controller 130. The controller 130 comprises a CPU 132 and a memory 134. The memory 134 stores a program 140 therein.

The plurality of printers 10, 110 is owned by a same owner (hereafter, “specific owner”). In the present embodiment, the specific owner is a legal entity. In a modification, the specific owner may be an individual person. “Owning” herein mentioned may not be limited to possession, but may encompass other forms such as rental.

### (Configuration of Management Server 200)

Hereafter, the management server 200 will be referred to as “server 200”. The server 200 is a server configured to manage status information of each of the printers 10, 110. In the present embodiment, the server 200 is installed on the Internet 6 by a vendor of the printers 10, 110. In a modification, the server 200 may be provided by a business entity different from the above-mentioned vendor. Also, in another modification, the server 200 may not be installed on the Internet 6. In this case, the respective printers 10, 110 and the server 200 may be connected to a same LAN.

The server 200 comprises a communication interface 218 and a controller 230. The respective parts 218, 230 are connected to a bus line. The communication interface 218 is connected to the Internet 6. The controller 230 comprises a CPU 232 and a memory 234. The memory 234 is composed of, for example, a ROM, a RAM, and stores a program 240 therein. The CPU 232 realizes various processes in accordance with the program 240 in the memory 234.

The memory 234 further stores a management table 250. The management table 250 stores status information of the printers 10, 110 that are owned by the above-mentioned specific owner and status information of several printers that are owned by different owner(s). The management table 250 stores the serial number, the status information, and a user ID in association with each other. The serial number is a serial number of a printer. The user ID is information identifying who owns the printer. The user ID of the above specific owner who owns the printers 10, 110 is “U1”.

### Outline of the Art Exemplified in the Present Embodiment

In the present embodiment, the server 200 periodically receives the status information from each of the printers 10, 110, and stores the respective status information of the printers 10, 110 in the management table 250. Then, the server 200 can provide the status information of the printers 10, 110 to a business entity which conducts maintenance service of printers (hereafter, “service entity”). In this case, for example, if some kind of malfunction occurs in a certain printer among the printers 10, 110, the service entity can acknowledge that occurrence, and conduct work for repairing the malfunction. Such work includes, for example, operating that printer remotely, and/or directly operating that printer by visiting a place at which that printer is set up.

Here, once the server 200 can no longer receive the status information from a certain printer among the printers 10, 110, the server 200 can acknowledge that that printer has become unable to send the status information, that is, the printer is offline. Due to this, the service entity can also know that the printer is offline. However, if the printer is offline, the service entity cannot remotely operate the printer to resolve the offline state. Also, the service entity cannot know why the printer has become offline. That is, the service entity cannot know whether power of the printer was intentionally turned off by a user or whether a malfunction has occurred in the printer. If the printer is offline because of the former reason, it will be useless for the service entity to visit the place at which the printer is set up.

In order to reduce the above-mentioned useless work, if a malfunction occurs in a printer (e.g., 110) among the printers 10, 110 and that malfunction causes the printer to become offline, the present embodiment enables the user to issue a notification to the server 200 about the occurrence of the malfunction by using another printer (e.g., 10). Hereafter, the art exemplified in the present embodiment will be described in detail.

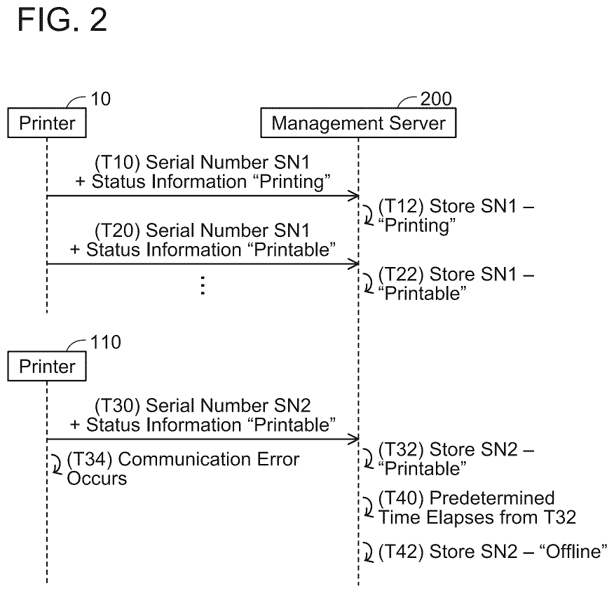

### (Management Process of Status Information: FIG. 2)

Firstly, with reference to FIG. 2, a management process of the status information will be described. The process is a process for each of the printers 10, 110 to send the status information to the server 200 and for the server 200 to store that status information. Hereinbelow, for easier understanding, processes executed by the CPUs 32, 132, 232 of the respective devices 10, 110, 200 will be described with each device as subject of action, without describing the CPU as subject of action.

The printer 10 periodically sends the status information to the server 200. For example, the printer 10 may send the status information to the server 200 at every certain time, or may send the status information to the server 200 each time the status changes. At a time of T10, the printer 10 is in middle of printing. Due to this, in T10, the printer 10 sends the serial number SN1 and the status information indicating “Printing” to the server 200.

When the server 200 receives the serial number SN1 and the status information from the printer 10 in T10, the server 200 stores the status information indicating “Printing” in association with the serial number SN1 in the management table 250 in T12. Here, although this is not illustrated, the server 200 has already stored the serial numbers SN1, SN2 of the printers 10, 110 that are owned by the above specific owner and the user ID “U1” of the above specific owner in association with each other. Accordingly, in T12, the server 200 further stores the user ID “U1” in association with the serial number SN1 and the status information.

At a time of T20, the printer 10 has completed printing, and is at a standby state where it is able to execute printing (being printable). Due to this, in T20, the printer 10 sends the serial number SN1 and the status information indicating “Printable” to the server 200.

When the server 200 receives the serial number SN1 and the status information from the printer 10 in T20, the server 200 changes the status information associated with the serial number SN1 from the status information indicating “Printing” to the status information indicating “Printable” in T22.

The printer 110 also sends repeatedly the status information to the server 200, in the same way as the printer 10 does. At a time of T30, the printer 110 is in a standby state where it is able to execute printing. Due to this, in T30, the printer 110 sends the serial number SN2 and the status information indicating “Printable” to the server 200.

When the server 200 receives the serial number SN2 and the status information from the printer 110 in T30, the server 200 stores, in association with the serial number SN2, the status information indicating “Printable” and the user ID “U1” in the management table 250 in T32.

Thereafter, in T34, a malfunction occurs in the printer 110. More specifically, the printer 110 changes its state to a communication error state of being unable to send the status information to the server 200.

In T40, the server 200 determines that a state of not receiving the status information from the printer 110 has continued for a predetermined time since the server 200 stored the status information of the printer 110 (i.e., from T32). In this case, in T42, the server 200 changes the status information associated with the serial number SN2 from the status information indicating “Printable” to the status information indicating “Offline”.

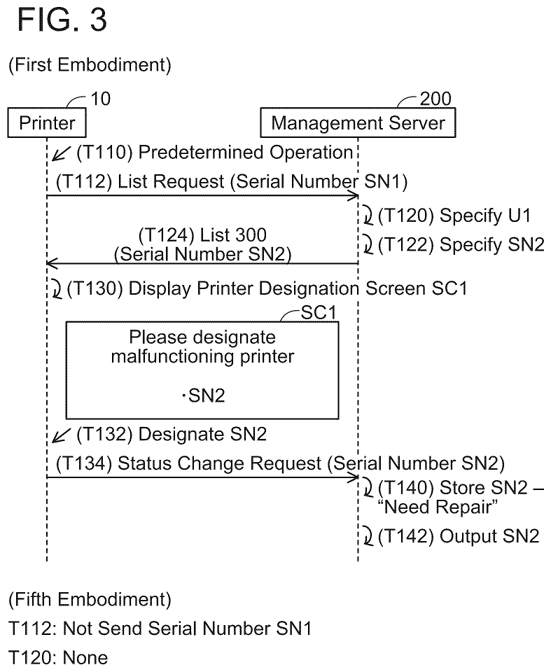

The server 200 is capable of outputting externally the serial numbers and the status information of the printers 10, 110. For example, when the server 200 is accessed by a terminal device of the service entity, the server 200 sends the serial numbers and the status information of the printers 10, 110 to that terminal device. Due to this, the service entity can see the serial numbers and the status information of the printers 10, 110. As mentioned above, the service entity cannot know the reason why the printer 110 has become offline even when the status information associated with the serial number SN2 indicates offline. When a process shown in next FIG. 3 is executed in such situation, the service entity can acknowledge that a malfunction has occurred in the printer 110.

### (Process for Notifying Malfunction of Printer 110: FIG. 3)

Next, with reference to FIG. 3, a process for the printer 10 notifying the server 200 about the malfunction of the printer 110 will be described. FIG. 3 shows processes continued from FIG. 2. The user of the printers 10, 110 acknowledges that the printer 110 has malfunctioned. For example, when the printer 110 displays information indicating communication error on the display unit 114, the user can acknowledge that the printer 110 has malfunctioned by looking at that information. In this case, in T110, the user performs a predetermined operation for notifying about a malfunctioning printer on the printer 10.

When the printer 10 receives the predetermined operation in T110, the printer 10 sends a list request including the serial number SN1 to the server 200 in T112.

When the server 200 receives the list request from the printer 10 in T112, the server 200 specifies the user ID “U1” associated with the serial number SN1 included in the list request from the management table 250 in T120. Next, in T122, the server 200 specifies the serial number SN2 associated with the status information indicating “Offline” from among one or more other serial numbers associated with the user ID “U1” from the management table 250. Then, in T124, the server 200 sends a list 300 including the specified serial number SN2 to the printer 10.

When the printer 10 receives the list 300 from the server 200 in T124, the printer 10 displays a printer designation screen SC1 including the serial number SN2 in the list 300 on the display unit 14 in T130. That is, the printer designation screen SC1 includes the serial number SN2 associated with the status information indicating “Offline”. The printer designation screen SC1 does not include a serial number which is not associated with the status information indicating “Offline”. As such, since only the serial number of the printer that may be malfunctioning is displayed, the user can easily designate the serial number SN2 of the malfunctioning printer 110. Also, the printer designation screen SC1 does not include a serial number of a printer that is not associated with the user ID “U1”. As such, since printer(s) which the user does not have a permission to use are excluded, the user can easily designate the serial number SN2 of the printer 110 which the user himself/herself can use. Here, in the present case, since only one serial number SN2 is specified by the server 200 in T122, the printer designation screen SC1 including only one serial number SN2 is displayed in T130. However, if a plurality of serial numbers that is associated with the user ID “U1” and the status information indicating “Offline” is specified in T122, the printer designation screen SC1 including the plurality of serial numbers is displayed in T130.

In T132, the printer 10 receives designation of the serial number SN2 included in the printer designation screen SC1. In this case, in T134, the printer 10 sends a status change request including the serial number SN2 to the server 200.

When the server 200 receives the status change request from the printer 10 in T134, the server 200 changes the status information associated with the serial number SN2 included in the status change request from the status information indicating “Offline” to status information indicating “Need Repair” in T140. Then, when the server 200 is accessed by the terminal device of the service entity, in T142 the server 200 sends the serial numbers and the status information of the printers 10, 110 to the terminal device. Due to this, the service entity can know that the status information associated with the serial number SN2 indicates “Need Repair”. That is, the service entity can know that the printer 110 has become offline due to some sort of malfunction having occurred in the printer 110. Accordingly, the service entity can visit the place where the printer 110 is set up, and directly operate the printer 110 to repair the printer 110, and/or install a new printer to replace the printer 110.

### Effects by Present Embodiment

According to the present embodiment, by displaying the printer designation screen SC1 (T130), the printer 10 can receive the designation of the printer 110 (T132) after the printer 110 has changed its state to the status of being unable to send the status information to the server 200. In this case, the printer 10 sends the serial number SN2 identifying the printer 110 to the server 200 (T134). As a result of this, the server 200 can output the serial number SN2 externally (T142). For this reason, the service entity can acknowledge the serial number SN2, and thus conduct work for resolving the malfunction of the printer 110.

### (Correspondence Relationships)

The printer 10 and the printer 110 are respectively an example for “first printer” and “second printer”. The list 300 is an example for “first list”. The respective printers corresponding to all the serial numbers stored in the management table 250 are an example for “N printers”. The two printers 10, 110 are an example for “M printers”. T10 and T20 in FIG. 2 are an example for “repeatedly send first status information”. T30 is an example for “repeatedly send second status information”. T112 is an example for “send a list request”. T120 to T124 are an example for “specify specific owner identification information associated with the first printer identification information included in the list request; specify the one or more printer identification information indicating the one or more printers that are unable to send status information to the server from among M printer identification information associated with the specific owner identification information; and send the first list”. T124 is an example for “receive, from the server, a first list”. T130 is an example for “cause the display to display a designation screen”. T134 is an example for “send second printer identification information”. T142 is an example for “output the second printer identification information externally”.

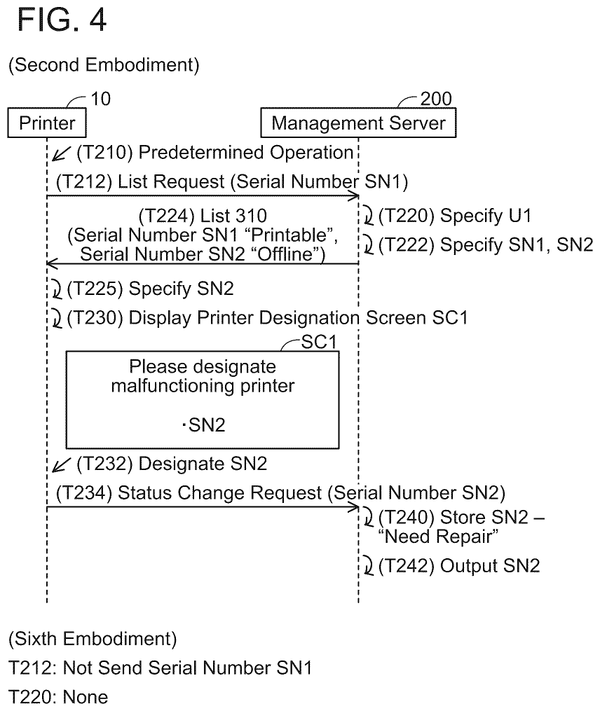

### Second Embodiment: FIG. 4

Next, with reference to FIG. 4, a second embodiment will be described. FIG. 4 shows processes continued from FIG. 2. T210, T212 are the same as T110, T112 in FIG. 3.

When the server 200 receives the list request from the printer 10 in T212, the server 200 specifies the user the user ID “U1” associated with the serial number SN1 included in the list request from the management table 250 in T220. Next, in T222, the server 200 specifies, for each of all the serial number SN1, SN2 that are associated with the user ID “U1”, the serial number and the status information associated with such serial number from the management table 250. Then, in T224, the server 200 sends a list 310 including the specified serial numbers SN1, SN2 and the specified respective status information to the printer 10.

When the printer 10 receives the list 310 from the server 200 in T224, the printer 10 specifies the serial number SN2 associated with the status information indicating “Offline” from the list 310 in T225. Next, in T230, the printer 10 displays the printer designation screen SC1 including the specified serial number SN2 on the display unit 14. As such, since only the serial number of the printer that might be malfunctioning is displayed, the user can easily designate the serial number SN2 of the printer 110 that is malfunctioning. Also, the printer(s) that the user does not have a permission to use are excluded, thus the user can easily designate the serial number SN2 of the printer 110 which the user himself/herself can use. Here, since in the present case only one serial number SN2 is specified by the printer 10 in T225, the printer designation screen SC1 including only the one serial number SN2 is displayed in T230. However, if plural serial numbers that are associated with the status information indicating “Offline” are specified in T225, the printer designation screen SC1 including the plural serial numbers is displayed in T230. T232 to T242 are the same as T132 to T142 in FIG. 3.

In the present embodiment, the list 310 is an example for “second list”. T212 is an example for “send a list request”. T220 to T224 are an example for “specify specific owner identification information associated with the first printer identification information included in the list request; and send the second list”. T224 is an example for “receive, from the server, a second list”.

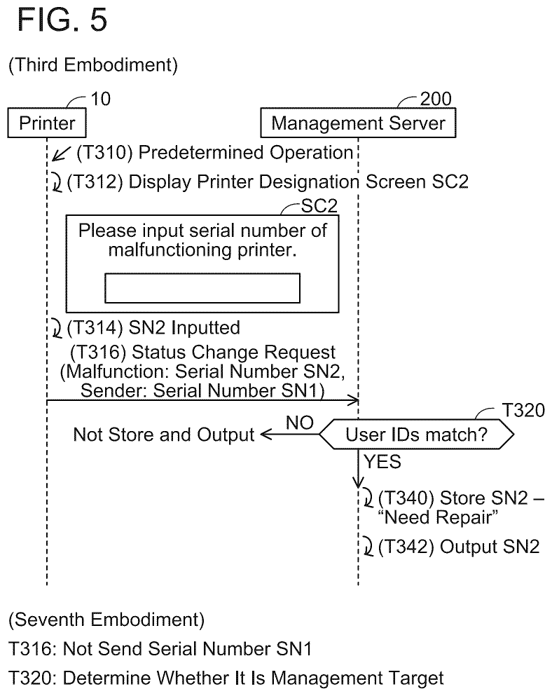

### Third Embodiment: FIG. 5

Next, with reference to FIG. 5, a third embodiment will be described. FIG. 5 shows processes continued from FIG. 2. When the printer 10 receives the predetermined operation in T310, the printer 10 displays a printer designation screen SC2 on the display unit 14 in T312. The printer designation screen SC2 includes an input field for directly inputting a serial number of a malfunctioning printer. In T314, the printer 10 receives an input of the serial number SN2. In this case, in T316, the printer 10 sends the status change request including the serial number SN2 as the serial number of the malfunctioning printer and also the serial number SN1 as the serial number of a sender printer which sent the request to the server 200.

When the server 200 receives the status change request from the printer 10 in T316, the server 200 executes a determination process in T320 based on the respective serial numbers included in the status change request. This determination process is a process for determining whether the serial number of the malfunctioning printer and the serial number of the sender printer are associated with a same user ID in the management table 250 or not. That is, the determination process is for determining whether the malfunctioning printer and the sender printer are owned by a same owner or not.

In the present case, the server 200 determines that the serial number SN2 of the malfunctioning printer and the serial number SN1 of the sender printer are associated with the same user ID “U1” (YES in T320), and the process proceeds to T340. T340 and T342 are the same as T140 and T142 in FIG. 3. When the server 200 determines that the serial number of the malfunctioning printer and the serial number of the sender printer are not associated with a same user ID (NO in T320), the server 200 does not execute T340 and T342. When a wrong serial number is inputted as the serial number of the malfunctioning printer in T314, it is determined in T320 that the malfunctioning printer and the sender printer are not owned by a same owner (NO in T320). Because T340 and T342 are not executed in such situation, the service entity does not have to conduct work for resolving the malfunction. In the present embodiment, T320 is an example for “determine whether the first printer identification information and the second printer identification information are associated with same owner identification information”.

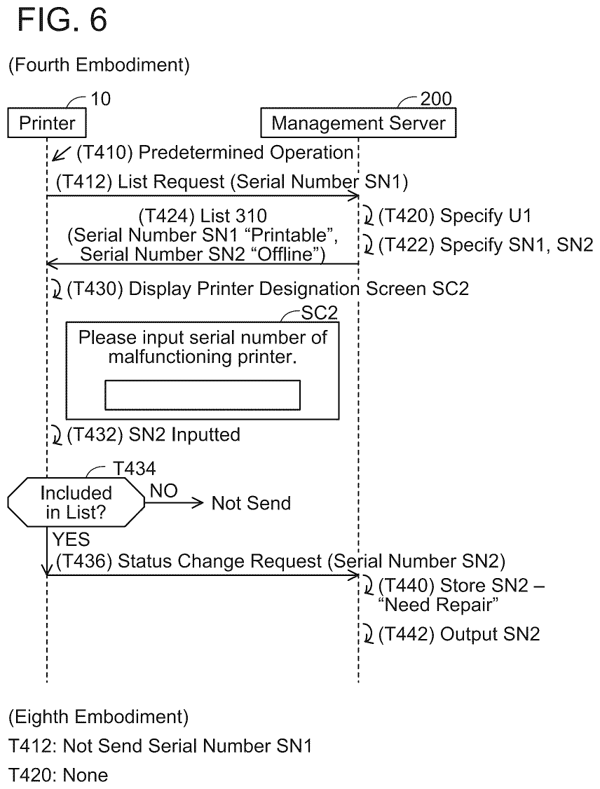

### Fourth Embodiment: FIG. 6

Next, with reference to FIG. 6, a fourth embodiment will be described. FIG. 6 shows processes continued from FIG. 2. T410 to T424 are the same as T210 to T224 in FIG. 4. When the printer 10 receives the list 310 from the server 200 in T424, the printer 10 displays the printer designation screen SC2 on the display unit 14 in T430. In T432, the printer 10 receives input of the serial number SN2.

In T434, the printer 10 executes a determination process based on the inputted serial number SN2 and the list 310. This determination process is a process for determining whether the inputted serial number is included in the list 310 or not. Because the respective serial numbers associated with a same user ID in the management table 250 are included in the list 310, such determination process is also for determining whether the malfunctioning printer and the sender printer are owned by a same owner, as in the third embodiment.

In the present case, the printer 10 determines that the inputted serial number SN2 is included in the list 310 (YES in T434), then in T436 the printer 10 sends the status change request including the serial number SN2 to the server 200. T440 and T442 are the same as T140 and T142 in FIG. 3. When the printer 10 determines that the inputted serial number is not included in the list 310 (NO in T434), the printer 10 does not execute T436. As a result of this, T440 and T442 are not executed. When a wrong serial number is inputted as the serial number of the malfunctioning printer in T432, it is determined in T434 that the malfunctioning printer and the sender printer are not owned by a same owner (NO in T434). Because T436 to T442 are not executed in such situation, the service entity does not have to conduct work for resolving the malfunction.

In the present embodiment, T412 is an example for “send a list request”. T420 to T424 are an example for “specify specific owner identification information associated with the first printer identification information included in the list request; and send a second list”. T424 is an example for “receive the second list”. T434 is an example for “determine whether the second printer identification information is included in the second list”.

### Fifth to Eighth Embodiments

In each of fifth to eighth embodiments, the server 200 manages only the status information of each of printer(s) owned by the above specific owner. That is, the server 200 is a server dedicated for the above specific owner. Accordingly, as shown in FIG. 1, in the table 250, there is no column in which a user ID is inputted. Also, there is no row which includes a user ID “U2”.

As shown in FIG. 3, in the fifth embodiment, a list request in T112 does not include the serial number SN1. When the server 200 receives the list request from the printer 10 in T112, the server 200 does not execute T120, and in T122 the server 200 specifies the serial number SN2 associated with the status information indicating “Offline” from the management table 250. Respective processes after that are the same as the first embodiment.

As shown in FIG. 4, in the sixth embodiment, a list request of T212 does not include the serial number SN1. When the server 200 receives the list request from the printer 10 in T212, the server 200 does not execute T220, and in T222 the server 200 specifies, for each of all the serial numbers SN1, SN2, the serial number and the status information associated with such serial number from the management table 250. Respective processes after that are the same as the second embodiment.

As shown in FIG. 5, in the seventh embodiment, a status change request in T316 does not include the serial number SN1 of the sender printer. When the server 200 receives the status change request from the printer 10 in T316, the server 200 does not determine in T320 whether the serial number of the malfunctioning printer and the serial number of the sender printer are associated with a same user ID or not. Instead, in T320 the server 200 determines whether the serial number of the malfunctioning printer included in the status change request is included in the management table 250 or not. That is, the server 200 determines whether the malfunctioning printer is a printer to be managed or not. Respective processes after that are the same as the third embodiment.

As shown in FIG. 6, in the eighth embodiment, a list request of T412 does not include the serial number SN1. When the server 200 receives the list request from the printer 10 in T412, the server 200 does not execute T420, and in T422 the server 200 specifies, for each of all the serial numbers SN1, SN2, the serial number and the status information associated with such serial number from the management table 250. Respective processes after that are the same as the fourth embodiment.

In the above-described fifth to eighth embodiments, the two printers 10, 110 are an example for “N printers” and “M printers”. That is, the M may be a different value from N as in the first to fourth embodiments, or may be the same value as the N as in the above-described fifth to eighth embodiments.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(Modification 1) The outputting process in T142 in FIG. 3 may not be limited to sending the information of the printers 10, 110 to the terminal device of the service entity, but may comprise, for example, displaying the serial number SN2 associated with the status information indicating “Need Repair” on a monitor connected to the server 200. In another modification, the outputting process may comprise sending an email including the serial number SN2 to an email address of the service entity. In general terms, “output the second printer identification information externally” may include any outputting method to make the second printer identification information acknowledged by the service entity.

(Modification 2) In T122 in FIG. 3, the server 200 may specify all the serial numbers SN1, SN2 associated with the user ID “U1” from the management table 250, and in T124 may send the list 300 including all the specified serial numbers SN1, SN2 to the printer 10. In this case, in T130, the printer 10 displays the printer designation screen SC1 including all the serial numbers SN1, SN2 on the display unit 14. In general terms, “one or more printers” may include a printer which is able to send the status information to the server.

(Modification 3) In the above embodiments, the processes of the respective steps of FIG. 2 to 6 are realized by software (e.g. programs 40, 140, 240), but at least one of these processes may be realized by hardware such as a logic circuitry.

What is claimed is:

1. A communication system comprising a first printer, a second printer, and a server, wherein
the first printer comprises a first printer controller configured to repeatedly send first status information indicating a status of the first printer to the server,
the second printer comprises a second printer controller configured to repeatedly send second status information indicating a status of the second printer to the server,
the first printer further comprises a display,
the first printer controller is further configured to:
cause the display to display a designation screen for designating a printer that is unable to send status information to the server; and
send second printer identification information identifying the second printer to the server in a case where the second printer is designated in the designation screen after a state of the second printer has changed from a state of being able to send the second status information to the server to a state of being unable to send the second status information to the server, and
the server comprises a server controller configured to output the second printer identification information externally in a case where the second printer identification information is received from the first printer.

2. The communication system as in claim 1,
wherein M printers including the first printer and the second printer are owned by a specific owner, M being an integer equal to or greater than 2, and
the designation screen includes one or more printer identification information indicating one or more printers among the M printers, the one or more printer identification information including the second printer identification information.

3. The communication system as in claim 2,
wherein each of the one or more printers is a printer that is unable to send status information to the server, and
the designation screen does not include one or more printer identification information indicating one or more printers among the M printers, each of the one or more printer being a printer that is able to send status information to the server.

4. The communication system as in claim 3,
wherein the server further comprises a memory configured to store, for each of N printers, printer identification information identifying the printer and status information indicating a status of the printer in association with each other, N being an integer equal to or greater than 2,
the first printer controller is further configured to receive, from the server, a first list including the one or more printer identification information indicating the one or more printers that are unable to send status information to the server, and
the first printer controller is configured to cause the display to display the designation screen including the one or more printer identification information included in the first list.

5. The communication system as in claim 4,
wherein the N printers include the M printers and another printer which is owned by a different owner different from the specific owner,
the memory is configured to store, for each of the N printers, printer identification information identifying the printer, status information indicating a status of the printer, and owner identification information identifying an owner of the printer in association with each other,
the first printer controller is further configured to send a list request including first printer identification information identifying the first printer to the server, and
the server controller is further configured to, in a case where the list request is received from the first printer:
specify specific owner identification information associated with the first printer identification information included in the list request;
specify the one or more printer identification information indicating the one or more printers that are unable to send status information to the server from among M printer identification information associated with the specific owner identification information; and
send the first list including the one or more printer identification information to the first printer.

6. The communication system as in claim 3,
wherein the server further comprises a memory configured to store, for each of N printers, printer identification information identifying the printer and status information indicating a status of the printer in association with each other, N being an integer equal to or greater than 2,
the first printer controller is further configured to receive, from the server, a second list including, for each of the M printers among the N printers, printer identification information identifying the printer and status information indicating a status of the printer, and
the first printer controller is configured to:
specify, by using the second list, the one or more printer identification information indicating the one or more printers that are unable to send status information to the server; and
cause the display to display the designation screen including the one or more printer identification information.

7. The communication system as in claim 6,
wherein the N printers include the M printers and another printer which is owned by a different owner different from the specific owner,
the memory is further configured to store, for each of the N printers, printer identification information identifying the printer, status information indicating a status of the printer, and owner identification information identifying an owner of the printer in association with each other,
the first printer controller is further configured to send a list request including first printer identification information identifying the first printer to the server, and
the server controller is further configured to, in a case where the list request is received from the first printer:
specify specific owner identification information associated with the first printer identification information included in the list request; and
send the second list including, for each of M printer identification information associated with the specific owner identification information, the printer identification information and status information associated with the printer identification information to the first printer.

8. The communication system as in claim 1,
wherein the designation screen includes an input field for directly inputting printer identification information identifying a printer which is unable to send status information to the server.

9. The communication system as in claim 8,
wherein the server further comprises a memory configured to store, for each of N printers, printer identification information identifying the printer, status information indicating a status of the printer, and owner identification information identifying an owner of the printer in association with each other, N being an integer equal to or greater than 2,
in the case where the second printer is designated in the designation screen, the first printer controller is configured to send first printer identification information identifying the first printer and second printer identification information identifying the second printer to the sever, and
the server controller is further configured to, in a case where the first printer identification information and the second printer identification information are received from the first printer, determine whether the first printer identification information and the second printer identification information are associated with same owner identification information,
in a case where it is determined that the first printer identification information and the second printer identification information are associated with the same owner identification information, the server controller is configured to output the second printer identification information externally, and
in a case where it is determined that the first printer identification information and the second printer identification information are not associated with the same owner identification information, the second printer identification information is not outputted externally.

10. The communication system as in claim 8,
wherein the server further comprises a memory configured to store, for each of N printers, printer identification information identifying the printer, status information indicating a status of the printer, and owner identification information identifying an owner of the printer in association with each other, N being an integer equal to or greater than 2,
the first printer controller is further configured to send a list request including first printer identification information identifying the first printer to the server,
the server controller is further configured to, in a case where the list request is received from the first printer:
specify specific owner identification information associated with the first printer identification information included in the list request; and
send a second list including, for each of M printer identification information associated with the specific owner identification information, the printer identification information and status information associated with the printer identification information to the first printer, the M being an integer equal to or greater than 2,
the first printer controller is further configured to:
receive the second list from the server; and
in the case where the second printer is designated in the designation screen, determine whether the second printer identification information is included in the second list,
in a case where it is determined that the second printer identification information is included in the second list, the first printer controller is configured to send the second printer identification information to the server, and
in a case where it is determined that the second printer identification information is not included in the second list, the second printer identification information is not sent to the server.

11. A first printer comprising:
a display; and
a first printer controller,
wherein the first printer controller is configured to:
repeatedly send first status information indicating a status of the first printer to a server;
cause the display to display a designation screen for designating a printer that is unable to send status information to the server; and
send second printer identification information identifying a second printer to the server in a case where the second printer, which is different from the first printer, is designated in the designation screen after a state of the second printer has changed from a state of being able to send second status information indicating a status of the second printer to the server to a state of being unable to send the second status information to the server, wherein the second printer identification information is outputted externally by the server.

12. A non-transitory computer-readable storage medium storing computer-readable instructions for a first printer,
wherein the computer-readable instructions, when executed by a processor of the first printer, cause the first printer to:
repeatedly send first status information indicating a status of the first printer to a server;
cause a display of the first printer to display a designation screen for designating a printer that is unable to send status information to the server; and
send second printer identification information identifying the second printer to the server in a case where a second printer, which is different from the first printer, is designated in the designation screen after a state of the second printer has changed from a state of being able to send second status information indicating a status of the second printer to the server to a state of being unable to send the second status information to the server, wherein the second printer identification information is outputted externally by the server.
